(19) United States
(12) Patent Application Publication
(10) Pub. No.: US 2020/0320474 A1
(43) Pub. Date: Oct. 8, 2020

(54) COMPUTERIZED SYSTEMS AND METHODS FOR BUFFERED INVENTORY MANAGEMENT

(71) Applicant: COUPANG CORP., Seoul (KR)

(72) Inventors: Sun Young HONG, Seoul (KR); Hyun Yop JUNG, Seoul (KR); Ji Eun KIM, Seoul (KR); Byung Suk YANG, Anyang (KR); Sang Hun LEE, Kwang ju (KR)

(73) Assignee: COUPANG CORP.

(21) Appl. No.: 16/373,329

(22) Filed: Apr. 2, 2019

(51) Int. Cl. G06Q 10/08; G06Q 10/06; G06F 3/0482

(52) U.S. Cl. CPC G06Q 10/0875; G06F 3/0482; G06Q 10/06316; G06Q 10/06315

(57) ABSTRACT

Embodiments of the present disclosure include a computer-implemented system for managing inventory in a fulfillment center. The system may comprise a memory and at least one processor. The processor may be configured to execute the instructions to determine a quantity of an item available for picking, generate a supplement request for the item based on a comparison of the quantity of the item available with a predefined quantity of the item, and send data relating to the supplement request and a first indication requesting input of identification information, receive a first input to verify the identification information, send data relating to an item identifier, receive a second input representing the item identifier, send data relating to a second indication requesting recording of the item identifier, and store the first input, the second input and the recorded information in a database associated with the computer-implemented system.

### TECHNICAL FIELD

The present disclosure generally relates to computerized systems and methods for managing inventory in fulfillment centers. In particular, embodiments of the present disclosure relate to inventive and unconventional computerized systems, methods, and user interfaces for efficiently distributing tasks to workers moving items between different physical zones of a fulfillment center.

### BACKGROUND

Fulfillment centers (FCs) enable e-commerce merchants to outsource warehousing and shipping. Inventory management in FCs is an essential component of cultivating the best customer experience for online shoppers. Inventory management may include a number of steps ranging from receiving merchandise from sellers, stowing the received merchandise for easy picking access, packing the items, verifying the order, and package delivery. Although currently existing FCs and systems for inventory management in FCs are configured to handle large volumes of incoming and out-going merchandise, the efficiency and timeliness of the fulfillment of customer orders may be limited, partly because of inefficient stowing and segregation practices. For example, misidentified, misplaced, or mischaracterized items may cause shipment delays and customer dissatisfaction.

To mitigate such problems, a conventional FC may include multiple zones, each of which facilitates a specific step in the process of shipping items from FCs to customers. For example, merchandise from vendors is received and stored at the inbound dock or the buffer zone, picked and sorted based on customer orders in picking zone, packed in boxes and containers in packing zone, etc. However, picking zones cannot store large items or large quantities of items for extended periods of time because the stored items should be easily accessible to the pickers. While buffer zones can store items, use of heavy machinery to unload the incoming trucks may render the place unsafe for pickers to walk around.

More importantly, the conventional arrangement including a buffer zone and a picking zone may be inefficient for time-sensitive customer orders. For example, if there is an urgent customer order for an item that is either not available or not replenished in the picking zone, it may be very challenging and inefficient for the picker to look for the item in the buffer zone and satisfy the order in a timely manner.

In addition, conventional FCs employ a team of workers to ensure a smooth round-the-clock operation. One of the technical challenges in a warehouse may be prompt communication of information to workers on the floor such as urgent customer orders, priority shipments, etc. Currently existing logistics and inventory management systems lack the ability to account for expected or unexpected urgency in customer orders efficiently, possibly causing customer dissatisfaction and higher associated inventory costs.

Therefore, there is a need for improved methods and systems for efficient inventory management and moving items between different physical zones of a fulfillment center.

### SUMMARY

One aspect of the present disclosure is directed to a computer-implemented system for managing inventory in a fulfillment center. The system may comprise a memory storing instructions and at least one processor. The processor may be configured to execute the instructions to determine a quantity of an item available for picking and generate a supplement request for the item based on a comparison of the quantity of the item available with a predefined quantity of the item. The method may further comprise sending, to at least one user-device for display, the supplement request to transport the item from a first zone to a second zone of the fulfillment center, sending, to at least one user-device for display, a first indication requesting input of identification information, and receive, from at least one user-device, a first input to verify the identification information. Based on the identification information, the processor may be configured to send, to at least one user-device for display, an item identifier comprising at least one of a location information of the item in the first zone, a description of the item, or a supplemental quantity of the item to be transported to the second zone, receive, from at least one user-device, a second input representing the item identifier, send, to at least one user-device for display, a second indication requesting recording of the location information of the item, the description of the item, and the supplemental quantity of the item to be moved to the second zone, and store the first input, the second input and the recorded information in a database associated with the computer-implemented system.

Another aspect of the present disclosure is directed to a computer-implemented system for managing inventory in a fulfillment center. The system may comprise a memory storing instructions, and at least one processor. The processor may be configured to execute the instructions to send, to at least one user-device for display, a work request to transport a replenishment quantity of an item from a first zone to a second zone of the fulfillment center, send, to at least one user-device for display, a first indication requesting recording of a location information of the item in the first zone, a description of the item, and the replenishment quantity of the item to be transported to the second zone, and receive, from at least one user-device, a first input indicating whether a moving device configured to transport the replenishment quantity of the item is full. The processor may be configured to send, to at least one user-device for display, a second indication requesting shelving each of the replenishment quantity of the item in a storage space in the second zone based on the received first input, send, to at least one user-device for display, a third indication requesting recording of at least one of a location information of the storage space in the second zone, the replenishment quantity of the item shelved, and the description of the item shelved. The processor may be configured to receive, from at least one user-device, a second input to determine whether the each of the replenishment quantity of the item is shelved, and store the first input, the second input, and recorded information in a database associated with the computer-implemented system.

Yet another aspect of the present disclosure is directed to a method for moving items between physical zones in a fulfillment center. The method may comprise determining, using a computer-implemented system, a quantity of the item available for picking and generating a supplement request for the item based on a comparison of the available quantity with a predefined quantity of the item. The method may further comprise sending, to at least one user-device for display, the supplement request to transport the item from a first zone to a second zone of the fulfillment center, sending, to at least one user-device for display, a first indication requesting input of identification information, and receiving, from at least one user-device, a first input to verify the identification information. The method may comprise sending, to at least one user-device for display, based on the identification information, an item identifier comprising at least one of a location information of the item in the first zone, a description of the item, or a supplemental quantity of the item to be transported to the second zone, receiving, from at least one user-device, a second input representing the item identifier, display a second indication requesting recording the location information of the item, the description of the item, and the supplemental quantity of the item to be moved to the second zone, and display a work request to transport a replenishment quantity of an item from the second zone to a third zone of the fulfillment center. The method may further comprise sending, to at least one user-device for display, a third indication requesting recording of a location information of the item in the second zone, a description of the item, and the replenishment quantity of the item to be transported to the third zone, receiving, from at least one user-device, a third input indicating whether a moving device configured to transport the replenishment quantity of the item is full, sending, to at least one user-device for display, a fourth indication requesting shelving of each of the replenishment quantity of the item in a storage space in the third zone based on the received third input, sending, to at least one user-device for display, a fifth indication requesting recording at least one of a location information of the storage space in the second zone, the replenishment quantity of the item shelved, and the description of the item shelved, receiving, from at least one user-device, a fourth input to determine whether each of the replenishment quantity of the item is shelved, and storing each of the first input, the second input, the third input, the fourth input, the fifth input, and recorded information in a database associated with the computer-implemented system.

Other systems, methods, and computer-readable media are also discussed herein.

### BRIEF DESCRIPTION OF THE DRAWINGS

FIG. 1A is a schematic block diagram illustrating an exemplary embodiment of a network comprising computerized systems for communications enabling shipping, transportation, and logistics operations, consistent with the disclosed embodiments.

FIG. 1B depicts a sample Search Result Page (SRP) that includes one or more search results satisfying a search request along with interactive user interface elements, consistent with the disclosed embodiments.

FIG. 1C depicts a sample Single Display Page (SDP) that includes a product and information about the product along with interactive user interface elements, consistent with the disclosed embodiments.

FIG. 1D depicts a sample Cart page that includes items in a virtual shopping cart along with interactive user interface elements, consistent with the disclosed embodiments.

FIG. 1E depicts a sample Order page that includes items from the virtual shopping cart along with information regarding purchase and shipping, along with interactive user interface elements, consistent with the disclosed embodiments.

FIG. 2 is a diagrammatic illustration of an exemplary fulfillment center configured to utilize disclosed computerized systems, consistent with the disclosed embodiments.

FIG. 3 is a schematic illustration of an exemplary user-interface configured to utilize disclosed computerized systems, consistent with the disclosed embodiments.

FIG. 4 is a schematic illustration of an exemplary user-interface display for inventory management in the fulfillment center, consistent with the disclosed embodiments.

FIG. 5 is a schematic illustration of exemplary user-interface interactive elements for movement of items from a buffer zone to a drop zone of the fulfillment center, consistent with the disclosed embodiments.

FIG. 6 is a schematic illustration of exemplary user-interface interactive elements for movement of items from a drop zone to a picking zone of the fulfillment center, consistent with the disclosed embodiments.

FIG. 7 is a schematic of an exemplary process flow for moving items in a fulfillment center, consistent with the disclosed embodiments.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions, or modifications may be made to the components and steps illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope of the invention is defined by the appended claims.

Embodiments of the present disclosure are directed to systems and methods configured for inventory management and efficient distribution of tasks to workers moving items between different physical zones of a fulfillment center.

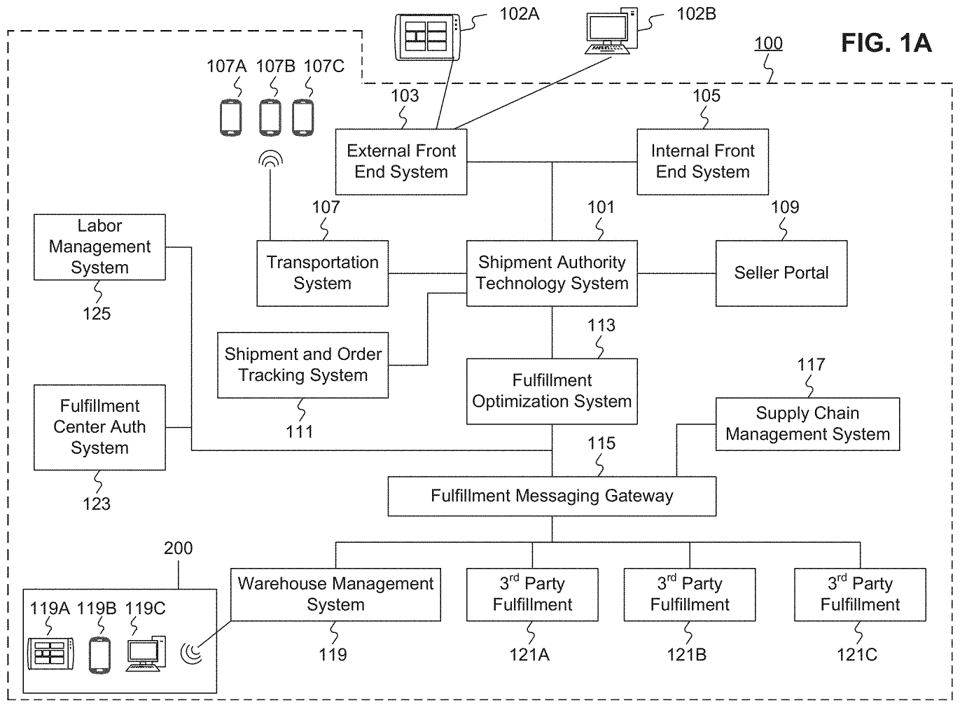

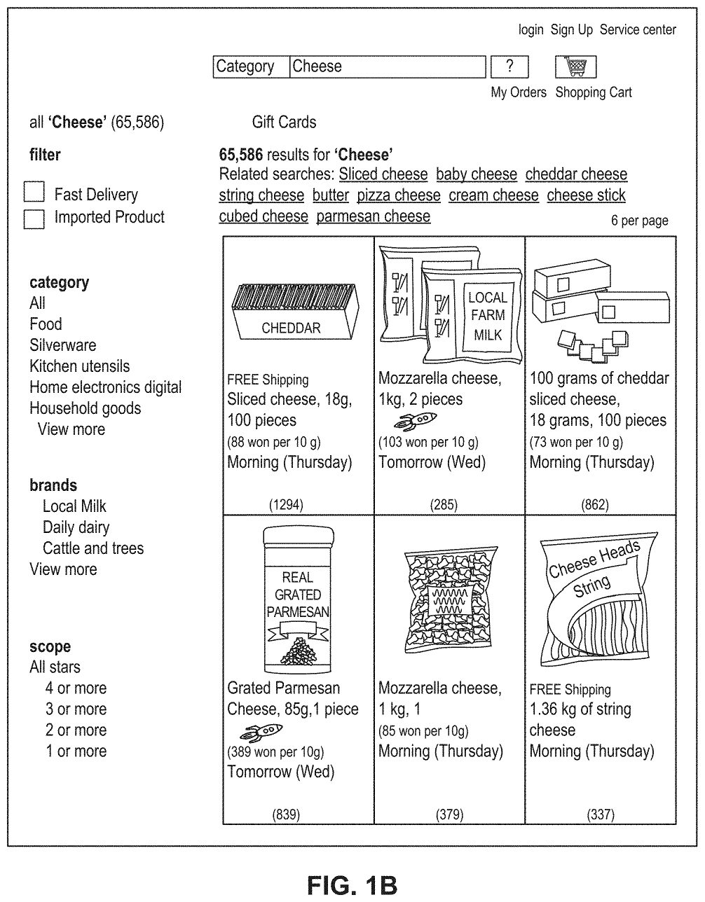

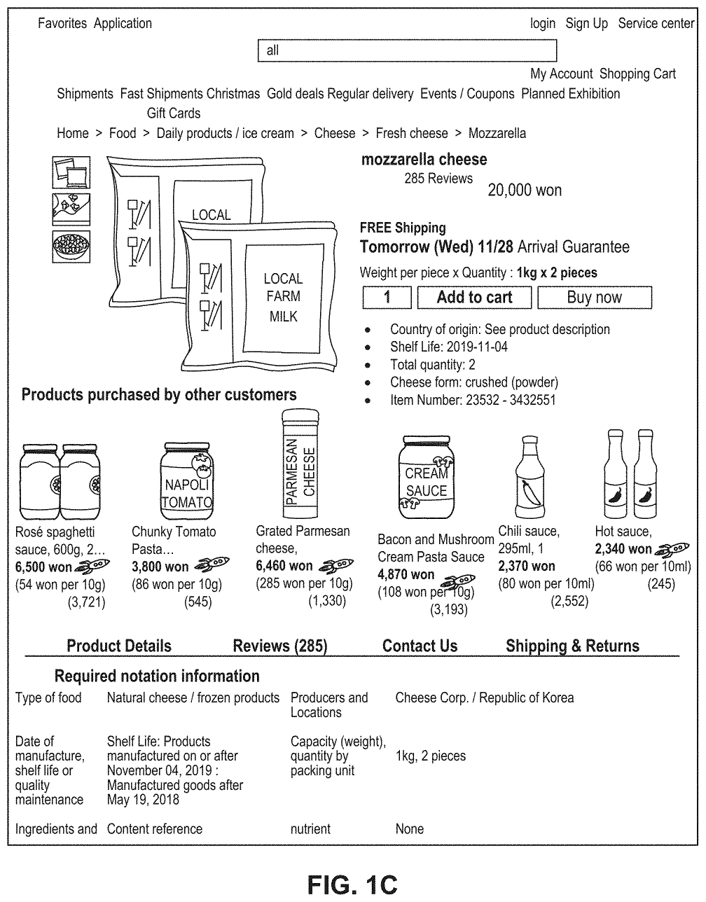

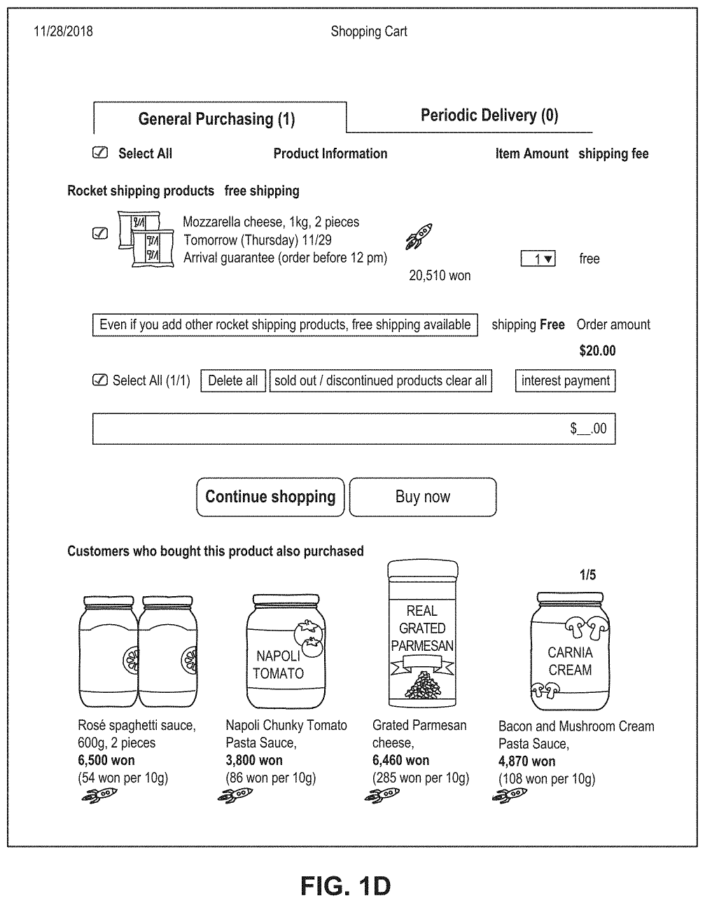

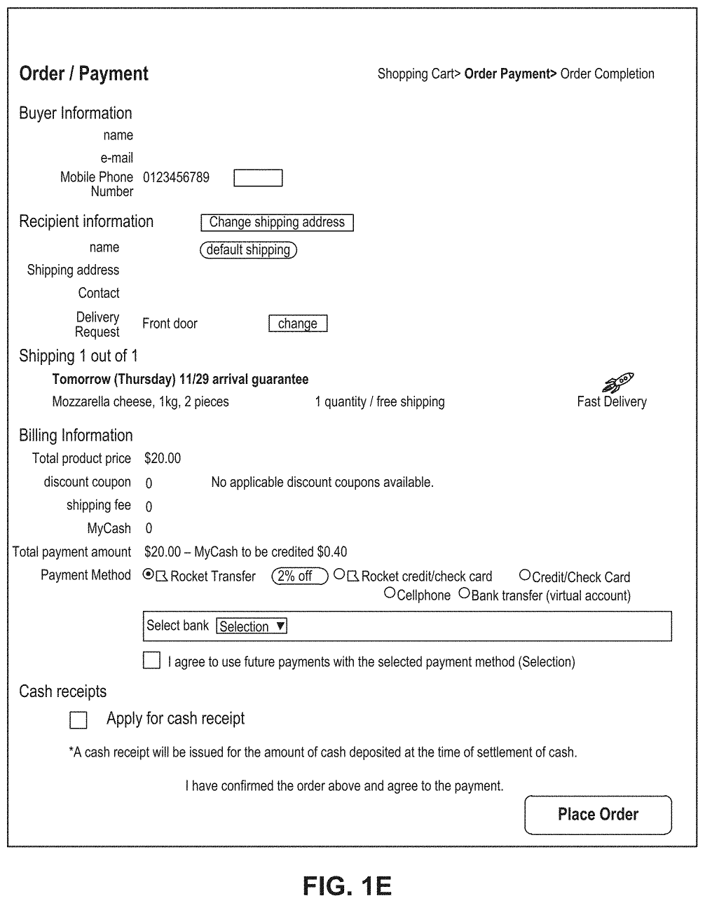

Referring to FIG. 1A, a schematic block diagram 100 illustrating an exemplary embodiment of a network comprising computerized systems for communications enabling shipping, transportation, and logistics operations is shown. As illustrated in FIG. 1A, system 100 may include a variety of systems, each of which may be connected to one another via one or more networks. The depicted systems include a shipment authority technology (SAT) system 101, an external front-end system 103, an internal front end system 105, a transportation system 107, mobile devices 107A, 107B, and 107C, seller portal 109, shipment and order tracking (SOT) system 111, fulfillment optimization (FO) system 113, fulfillment messaging gateway (FMG) 115, supply chain management (SCM) system 117, warehouse management system 119, mobile devices 119A, 119B, and 119C (depicted as being inside of fulfillment center (FC) 200), 3^{rd} party fulfillment systems 121A, 121B, and 121C, fulfillment center authorization system (FC Auth) 123, and labor management system (LMS) 125.

SAT system 101, in some embodiments, may be implemented as a computer system that monitors order status and delivery status. For example, SAT system 101 may determine whether an order is past its Promised Delivery Date (PDD) and may take appropriate action, including initiating a new order, reshipping the items in the non-delivered order, canceling the non-delivered order, initiating contact with the ordering customer, or the like. SAT system 101 may also monitor other data, including output (such as a number of packages shipped during a particular time period) and input (such as the number of empty cardboard boxes received for use in shipping). SAT system 101 may also act as a gateway between different devices in system 100, enabling communication (e.g., using store-and-forward or other techniques) between devices such as external front-end system 103 and FO system 113.

External front-end system 103, in some embodiments, may be implemented as a computer system that enables external users to interact with one or more systems in network 100. For example, in embodiments where network 100 enables the presentation of systems to enable users to place an order for an item, external front-end system 103 may be implemented as a web server that receives search requests, presents item pages, and solicits payment information. For example, external front-end system 103 may be implemented as a computer or computers running software such as the Apache HTTP Server, Microsoft Internet Information Services (IIS), NGINX, or the like. In other embodiments, external front-end system 103 may run custom web server software designed to receive and process requests from external devices (not depicted), acquire information from databases and other data stores based on those requests, and provide responses to the received requests based on acquired information.

In some embodiments, external front-end system 103 may include one or more of a web caching system, a database, a search system, or a payment system. In one aspect, external front-end system 103 may comprise one or more of these systems, while in another aspect, external front-end system 103 may comprise interfaces (e.g., server-to-server, database-to-database, or other network connections) connected to one or more of these systems.

An illustrative set of steps, illustrated by FIGS. 1B, 1C, 1D, and 1E, will help to describe some operations of external front-end system 103. External front-end system 103 may receive information from systems or devices in network 100 for presentation and/or display. For example, external front-end system 103 may host or provide one or more web pages, including a Search Result Page (SRP) (e.g., FIG. 1B), a Single Detail Page (SDP) (e.g., FIG. 1C), a Cart page (e.g., FIG. 1D), or an Order page (e.g., FIG. 1E). A user device (e.g., using mobile device 102A or computer 102B) may navigate to external front-end system 103 and request a search by entering information into a search box. External front-end system 103 may request information from one or more systems in network 100. For example, external front-end system 103 may request results from FO System 113 that satisfy the search request. External front-end system 103 may also request and receive (from FO System 113) a Promised Delivery Date or “PDD” for each product returned in the search results. The PDD, in some embodiments, represents an estimate of when a package will arrive at the user's desired location if ordered within a particular period of time, for example, by the end of the day (11:59 PM). (PDD is discussed further below with respect to FO System 113.)

External front-end system 103 may prepare an SRP (e.g., FIG. 1B) based on the information. The SRP may include information that satisfies the search request. For example, this may include pictures of products that satisfy the search request. The SRP may also include respective prices for each product, or information relating to enhanced delivery options for each product, PDD, weight, size, offers, discounts, or the like. External front-end system 103 may deliver the SRP to the requesting user device (e.g., via a network).

A user device may then select a product from the SRP, e.g., by clicking or tapping a user interface, or using another input device, to select a product represented on the SRP. The user device may formulate a request for information on the selected product and send it to external front-end system 103. In response, external front-end system 103 may request information related to the selected product. For example, the information may include additional information beyond that presented for a product on the respective SRP. This could include, for example, shelf life, country of origin, weight, size, number of items in package, handling instructions, or other information about the product. The information could also include recommendations for similar products (based on, for example, big data and/or machine learning analysis of customers who bought this product and at least one other product), answers to frequently asked questions, reviews from customers, manufacturer information, pictures, or the like.

External front-system 103 may prepare an SDP (Single Detail Page) (e.g., FIG. 1C) based on the received product information. The SDP may also include other interactive elements such as a “Buy Now” button, a “Add to Cart” button, a quantity field, a picture of the item, or the like. External front-end system 103 may deliver the SDP to the requesting user device (e.g., via a network).

The requesting user device may receive the SDP which lists the product information. Upon receiving the SDP, the user device may then interact with the SDP. For example, a user of the requesting user device may click or otherwise interact with a “Place in Cart” button on the SDP. This adds the product to a shopping cart associated with the user. The user device may transmit this request to add the product to the shopping cart to external front-end system 103.

External front-end system 103 may generate a Cart page (e.g., FIG. 1D). The Cart page, in some embodiments, lists the products that the user has added to a virtual “shopping cart.” A user device may request the Cart page by clicking on or otherwise interacting with an icon on the SRP, SDP, or other pages. The Cart page may, in some embodiments, list all products that the user has added to the shopping cart, as well as information about the products in the cart such as a quantity of each product, a price for each product per item, a price for each product based on an associated quantity, information regarding PDD, a delivery method, a shipping cost, user interface elements for modifying the products in the shopping cart (e.g., deletion or modification of a quantity), options for ordering other product or setting up periodic delivery of products, options for setting up interest payments, user interface elements for proceeding to purchase, or the like. A user at a user device may click on or otherwise interact with a user interface element (e.g., a button that reads “Buy Now”) to initiate the purchase of the product in the shopping cart. Upon doing so, the user device may transmit this request to initiate the purchase to external front-end system 103.

External front-end system 103 may generate an Order page (e.g., FIG. 1E) in response to receiving the request to initiate a purchase. The Order page, in some embodiments, re-lists the items from the shopping cart and requests input of payment and shipping information. For example, the Order page may include a section requesting information about the purchaser of the items in the shopping cart (e.g., name, address, e-mail address, phone number), information about the recipient (e.g., name, address, phone number, delivery information), shipping information (e.g., speed/method of delivery and/or pickup), payment information (e.g., credit card, bank transfer, check, stored credit), user interface elements to request a cash receipt (e.g., for tax purposes), or the like. External front-end system 103 may send the Order page to the user device.

The user device may enter information on the Order page and click or otherwise interact with a user interface element that sends the information to external front-end system 103. From there, external front-end system 103 may send the information to different systems in network 100 to enable the creation and processing of a new order with the products in the shopping cart.

In some embodiments, external front-end system 103 may be further configured to enable sellers to transmit and receive information relating to orders.

Internal front-end system 105, in some embodiments, may be implemented as a computer system that enables internal users (e.g., employees of an organization that owns, operates, or leases network 100) to interact with one or more systems in network 100. For example, in embodiments where network 101 enables the presentation of systems to enable users to place an order for an item, internal front-end system 105 may be implemented as a web server that enables users to view diagnostic and statistical information about orders, modify item information, or review statistics relating to orders. For example, internal front-end system 105 may be implemented as a computer or computers running software such as the Apache HTTP Server, Microsoft Internet Information Services (IIS), NGINX, or the like. In other embodiments, internal front-end system 105 may run custom web server software designed to receive and process requests from devices depicted in network 100 (as well as other devices not depicted), acquire information from databases and other data stores based on those requests, and provide responses to the received requests based on acquired information.

In some embodiments, internal front-end system 105 may include one or more of a web caching system, a database, a search system, a payment system, an analytics system, an order monitoring system, or the like. In one aspect, internal front-end system 105 may comprise one or more of these systems, while in another aspect, internal front-end system 105 may comprise interfaces (e.g., server-to-server, database-to-database, or other network connections) connected to one or more of these systems.

Transportation system 107, in some embodiments, may be implemented as a computer system that enables communication between devices in network 100 and mobile devices 107A-107C. Transportation system 107, in some embodiments, may receive information from one or more mobile devices 107A-107C (e.g., mobile phones, smart phones, PDAs, or the like). For example, in some embodiments, mobile devices 107A-107C may comprise devices operated by delivery workers. The delivery workers, who may be permanent, temporary, or shift employees, may utilize mobile devices 107A-107C to effect delivery of packages ordered by users. For example, to deliver a package, the delivery worker may receive a notification on a mobile device indicating which package to deliver and where to deliver it. Upon arriving at the delivery location, the delivery worker may locate the package (e.g., in the back of a truck or in a crate of packages), scan or otherwise capture data associated with an identifier on the package (e.g., a barcode, an image, a text string, an RFID tag, or the like) using the mobile device, and deliver the package (e.g., by leaving it at a front door, leaving it with a security guard, handing it to the recipient, or the like). In some embodiments, the delivery worker may capture photo(s) of the package and/or may obtain a signature. The mobile device may send a communication to transportation system 107 including information about the delivery, including, for example, time, date, GPS location, photo(s), an identifier associated with the delivery worker, an identifier associated with the mobile device, or the like. Transportation system 107 may store this data in a database (not pictured) for access by other systems in network 100. Transportation system 107 may, in some embodiments, use this information to prepare and send tracking data to other systems indicating the location of a particular package.

In some embodiments, certain users may use one kind of mobile device (e.g., permanent workers may use a specialized PDA with custom hardware such as a barcode scanner, stylus, and other devices) while other users may use other kinds of mobile devices (e.g., temporary or shift workers may utilize off-the-shelf mobile phones and/or smartphones).

In some embodiments, transportation system 107 may associate a user with each device. For example, transportation system 107 may store a relationship between a user (represented by, e.g., a user identifier, an employee identifier, or a phone number) and a mobile device (represented by, e.g., an International Mobile Equipment Identity (IMEI), an International Mobile Subscription Identifier (IMSI), a phone number, a Universal Unique Identifier (UUID), or a Globally Unique Identifier (GUID)). Transportation system 107 may use this relationship in conjunction with data received on deliveries to analyze data stored in the database in order to determine, among other things, a location of the worker, an efficiency of the worker, or a speed of the worker.

Seller portal 109, in some embodiments, may be implemented as a computer system that enables sellers or other outside entities to electronically communicate with other aspects of information relating to orders. For example, a seller may utilize a computer system (not pictured) to upload or provide product information, order information, contact information, or the like, for products that the seller wishes to sell through system 100.

Shipment and order tracking system 111, in some embodiments, may be implemented as a computer system that receives, stores, and forwards information regarding the location of packages ordered by customers (e.g., by a user using devices 102A-102B). In some embodiments, shipment and order tracking system 111 may request or store information from web servers (not pictured) operated by shipping companies that deliver packages ordered by customers.

In some embodiments, shipment and order tracking system 111 may request and store information from systems depicted in network 100. For example, shipment and order tracking system 111 may request information from transportation system 107. As discussed above, transportation system 107 may receive information from one or more mobile devices 107A-107C (e.g., mobile phones, smart phones, PDAs, or the like) that are associated with one or more of a user (e.g., a delivery worker) or a vehicle (e.g., a delivery truck). In some embodiments, shipment and order tracking system 111 may also request information from warehouse management system (WMS) 119 to determine the location of individual packages inside of a fulfillment center (e.g., fulfillment center 200). Shipment and order tracking system 111 may request data from one or more of transportation system 107 or WMS 119, process it, and present it to a device (e.g., user devices 102A and 102B) upon request.

Fulfillment optimization (FO) system 113, in some embodiments, may be implemented as a computer system that stores information for customer orders from other systems (e.g., external front end-system 103 and/or shipment and order tracking system 111). FO system 113 may also store information describing where particular items are held or stored. For example, some items that customers order may be stored only in one fulfillment center, while other items may be stored in multiple fulfillment centers. In still other embodiments, certain fulfilment centers may be designed to store only a particular set of items (e.g., fresh produce or frozen products). FO system 113 stores this information as well as associated information (e.g., quantity, size, date of receipt, expiration date, etc.).

FO system 113 may also calculate a corresponding PDD (promised delivery date) for each product. The PDD, in some embodiments, may be based on one or more factors. For example, FO system 113 may calculate a PDD for a product based on a past demand for a product (e.g., how many times that product was ordered during a period of time), an expected demand for a product (e.g., how many customers are forecast to order the product during an upcoming period of time), a network-wide past demand indicating how many products were ordered during a period of time, a network-wide expected demand indicating how many products are expected to be ordered during an upcoming period of time, one or more counts of the product stored in each fulfillment center 200, which fulfillment center stores each product, expected or current orders for that product, or the like.

In some embodiments, FO system 113 may determine a PDD for each product on a periodic basis (e.g., hourly) and store it in a database for retrieval or sending to other systems (e.g., external front end-system 103, SAT system 101, shipment and order tracking system 111). In other embodiments, FO system 113 may receive electronic requests from one or more systems (e.g., external front-end system 103, SAT system 101, WMS 119, shipment and order tracking system 111) and calculate the PDD on demand.

Fulfilment messaging gateway (FMG) 115, in some embodiments, may be implemented as a computer system that receives communications from one or more systems in network 100, such as FO system 113, converts the data in the communications to another format, and forward the data in the converted format to other systems, such as WMS 119 or 3^{rd} party fulfillment systems 121A, 121B, or 121C, and vice versa.

Supply chain management (SCM) system 117, in some embodiments, may be implemented as a computer system that performs forecasting functions. For example, SCM system 117 may determine forecasted level of demand for a particular product based on, for example, based on a past demand for products, an expected demand for a product, a network-wide past demand, a network-wide expected demand, a count of products stored in each fulfillment center 200, expected or current orders for each product, or the like. In response to this determined forecasted level and the amount of each product across all fulfillment centers, SCM system 117 may generate one or more purchase orders to satisfy the expected demand for a particular product.

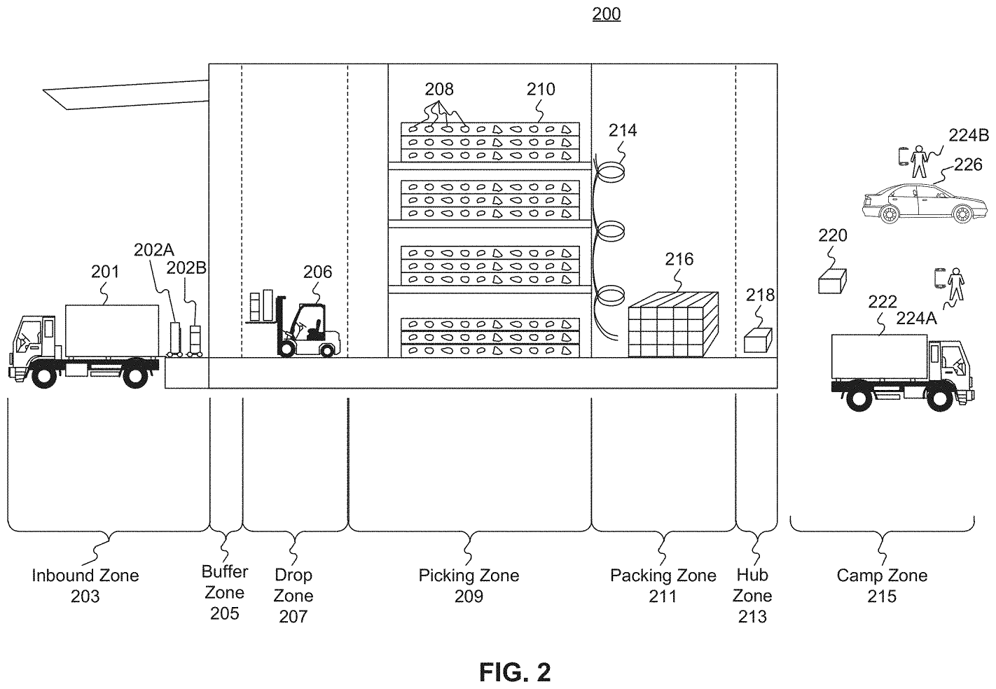

Warehouse management system (WMS) 119, in some embodiments, may be implemented as a computer system that monitors workflow. For example, WMS 119 may receive event data from individual devices (e.g., devices 107A-107C or 119A-119C) indicating discrete events. For example, WMS 119 may receive event data indicating the use of one of these devices to scan a package. As discussed below with respect to fulfillment center 200 and FIG. 2, during the fulfillment process, a package identifier (e.g., a barcode or RFID tag data) may be scanned or read by machines at particular stages (e.g., automated or handheld barcode scanners, RFID readers, high-speed cameras, devices such as tablet 119A, mobile device/PDA 119B, computer 119C, or the like). WMS 119 may store each event indicating a scan or a read of a package identifier in a corresponding database (not pictured) along with the package identifier, a time, date, location, user identifier, or other information, and may provide this information to other systems (e.g., shipment and order tracking system 111).

WMS 119, in some embodiments, may store information associating one or more devices (e.g., devices 107A-107C or 119A-119C) with one or more users associated with network 100. For example, in some situations, a user (such as a part- or full-time employee) may be associated with a mobile device in that the user owns the mobile device (e.g., the mobile device is a smartphone). In other situations, a user may be associated with a mobile device in that the user is temporarily in custody of the mobile device (e.g., the user checked the mobile device out at the start of the day, will use it during the day, and will return it at the end of the day).

WMS 119, in some embodiments, may maintain a work log for each user associated with network 100. For example, WMS 119 may store information associated with each employee, including any assigned processes (e.g., unloading trucks, picking items from a pick zone, rebin wall work, packing items), a user identifier, a location (e.g., a floor or zone in a fulfillment center 200), a number of units moved through the system by the employee (e.g., number of items picked, number of items packed), an identifier associated with a device (e.g., devices 119A-119C), or the like. In some embodiments, WMS 119 may receive check-in and check-out information from a timekeeping system, such as a timekeeping system operated on a device 119A-119C.

3^{rd} party fulfillment (3PL) systems 121A-121C, in some embodiments, represent computer systems associated with third-party providers of logistics and products. For example, while some products are stored in fulfillment center 200 (as discussed below with respect to FIG. 2), other products may be stored off-site, may be produced on demand, or may be otherwise unavailable for storage in fulfillment center 200. 3PL systems 121A-121C may be configured to receive orders from FO system 113 (e.g., through FMG 115) and may provide products and/or services (e.g., delivery or installation) to customers directly.

Fulfillment Center Auth system (FC Auth) 123, in some embodiments, may be implemented as a computer system with a variety of functions. For example, in some embodiments, FC Auth 123 may act as a single-sign on (SSO) service for one or more other systems in network 100. For example, FC Auth 123 may enable a user to log in via internal front-end system 105, determine that the user has similar privileges to access resources at shipment and order tracking system 111, and enable the user to access those privileges without requiring a second log in process. FC Auth 123, in other embodiments, may enable users (e.g., employees) to associate themselves with a particular task. For example, some employees may not have an electronic device (such as devices 119A-119C) and may instead move from task to task, and zone to zone, within a fulfillment center 200, during the course of a day. FC Auth 123 may be configured to enable those employees to indicate what task they are performing and what zone they are in at different times of day.

Labor management system (LMS) 125, in some embodiments, may be implemented as a computer system that stores attendance and overtime information for employees (including full-time and part-time employees). For example, LMS 125 may receive information from FC Auth 123, WMA 119, devices 119A-119C, transportation system 107, and/or devices 107A-107C.

The particular configuration depicted in FIG. 1A is an example only. For example, while FIG. 1A depicts FC Auth system 123 connected to FO system 113 through FMG 115, not all embodiments require this particular configuration. Indeed, in some embodiments, the systems in network 100 may be connected to one another through one or more public or private networks, including the Internet, an Intranet, a WAN (Wide-Area Network), a MAN (Metropolitan-Area Network), a wireless network compliant with the IEEE 802.11a/b/g/n Standards, a leased line, or the like. In some embodiments, one or more of the systems in network 100 may be implemented as one or more virtual servers implemented at a data center, server farm, or the like.

FIG. 2 depicts a fulfillment center 200. Fulfillment center 200 is an example of a physical location that stores items for shipping to customers when ordered. Fulfillment center (FC) 200 may be divided into multiple zones, each of which are depicted in FIG. 2. These “zones,” in some embodiments, may be thought of as virtual divisions between different stages of a process of receiving items, storing the items, retrieving the items, and shipping the items. So, while the “zones” are depicted in FIG. 2, other divisions of zones are possible, and the zones in FIG. 2 may be omitted, duplicated, or modified in some embodiments.

Inbound zone 203 represents an area of FC 200 where items are received from sellers who wish to sell products using network 100 from FIG. 1. For example, a seller may deliver items 202A and 202B using truck 201. Item 202A may represent a single item large enough to occupy its own shipping pallet, while item 202B may represent a set of items that are stacked together on the same pallet to save space.

A worker will receive the items in inbound zone 203 and may optionally check the items for damage and correctness using a computer system (not pictured). For example, the worker may use a computer system to compare the quantity of items 202A and 202B to an ordered quantity of items. If the quantity does not match, that worker may refuse one or more of items 202A or 202B. If the quantity does match, the worker may move those items (using, e.g., a dolly, a handtruck, a forklift, or manually) to buffer zone 205. Buffer zone 205 may be a temporary storage area for items that are not currently needed in the picking zone, for example, because there is a high enough quantity of that item in the picking zone to satisfy forecasted demand. In some embodiments, forklifts 206 operate to move items around buffer zone 205 and between inbound zone 203 and drop zone 207. If there is a need for items 202A or 202B in the picking zone (e.g., because of forecasted demand), a forklift may move items 202A or 202B to drop zone 207.

Drop zone 207 may be an area of FC 200 that stores items before they are moved to picking zone 209. A worker assigned to the picking task (a “picker”) may approach items 202A and 202B in the picking zone, scan a barcode for the picking zone, and scan barcodes associated with items 202A and 202B using a mobile device (e.g., device 119B). The picker may then take the item to picking zone 209 (e.g., by placing it on a cart or carrying it).

Picking zone 209 may be an area of FC 200 where items 208 are stored on storage units 210. In some embodiments, storage units 210 may comprise one or more of physical shelving, bookshelves, boxes, totes, refrigerators, freezers, cold stores, or the like. In some embodiments, picking zone 209 may be organized into multiple floors. In some embodiments, workers or machines may move items into picking zone 209 in multiple ways, including, for example, a forklift, an elevator, a conveyor belt, a cart, a handtruck, a dolly, an automated robot or device, or manually. For example, a picker may place items 202A and 202B on a handtruck or cart in drop zone 207 and walk items 202A and 202B to picking zone 209.

A picker may receive an instruction to place (or “stow”) the items in particular spots in picking zone 209, such as a particular space on a storage unit 210. For example, a picker may scan item 202A using a mobile device (e.g., device 119B). The device may indicate where the picker should stow item 202A, for example, using a system that indicate an aisle, shelf, and location. The device may then prompt the picker to scan a barcode at that location before stowing item 202A in that location. The device may send (e.g., via a wireless network) data to a computer system such as WMS 119 in FIG. 1 indicating that item 202A has been stowed at the location by the user using device 119B.

Once a user places an order, a picker may receive an instruction on device 119B to retrieve one or more items 208 from storage unit 210. The picker may retrieve item 208, scan a barcode on item 208, and place it on transport mechanism 214. While transport mechanism 214 is represented as a slide, in some embodiments, transport mechanism may be implemented as one or more of a conveyor belt, an elevator, a cart, a forklift, a handtruck, a dolly, a cart, or the like. Item 208 may then arrive at packing zone 211.

Packing zone 211 may be an area of FC 200 where items are received from picking zone 209 and packed into boxes or bags for eventual shipping to customers. In packing zone 211, a worker assigned to receiving items (a “rebin worker”) will receive item 208 from picking zone 209 and determine what order it corresponds to. For example, the rebin worker may use a device, such as computer 119C, to scan a barcode on item 208. Computer 119C may indicate visually which order item 208 is associated with. This may include, for example, a space or “cell” on a wall 216 that corresponds to an order. Once the order is complete (e.g., because the cell contains all items for the order), the rebin worker may indicate to a packing worker (or “packer”) that the order is complete. The packer may retrieve the items from the cell and place them in a box or bag for shipping. The packer may then send the box or bag to a hub zone 213, e.g., via forklift, cart, dolly, handtruck, conveyor belt, manually, or otherwise.

Hub zone 213 may be an area of FC 200 that receives all boxes or bags (“packages”) from packing zone 211. Workers and/or machines in hub zone 213 may retrieve package 218 and determine which portion of a delivery area each package is intended to go to, and route the package to an appropriate camp zone 215. For example, if the delivery area has two smaller sub-areas, packages will go to one of two camp zones 215. In some embodiments, a worker or machine may scan a package (e.g., using one of devices 119A-119C) to determine its eventual destination. Routing the package to camp zone 215 may comprise, for example, determining a portion of a geographical area that the package is destined for (e.g., based on a postal code) and determining a camp zone 215 associated with the portion of the geographical area.

Camp zone 215, in some embodiments, may comprise one or more buildings, one or more physical spaces, or one or more areas, where packages are received from hub zone 213 for sorting into routes and/or sub-routes. In some embodiments, camp zone 215 is physically separate from FC 200 while in other embodiments camp zone 215 may form a part of FC 200.

Workers and/or machines in camp zone 215 may determine which route and/or sub-route a package 220 should be associated with, for example, based on a comparison of the destination to an existing route and/or sub-route, a calculation of workload for each route and/or sub-route, the time of day, a shipping method, the cost to ship the package 220, a PDD associated with the items in package 220, or the like. In some embodiments, a worker or machine may scan a package (e.g., using one of devices 119A-119C) to determine its eventual destination. Once package 220 is assigned to a particular route and/or sub-route, a worker and/or machine may move package 220 to be shipped. In exemplary FIG. 2, camp zone 215 includes a truck 222, a car 226, and delivery workers 224A and 224B. In some embodiments, truck 222 may be driven by delivery worker 224A, where delivery worker 224A is a full-time employee that delivers packages for FC 200 and truck 222 is owned, leased, or operated by the same company that owns, leases, or operates FC 200. In some embodiments, car 226 may be driven by delivery worker 224B, where delivery worker 224B is a “flex” or occasional worker that is delivering on an as-needed basis (e.g., seasonally). Car 226 may be owned, leased, or operated by delivery worker 224B.

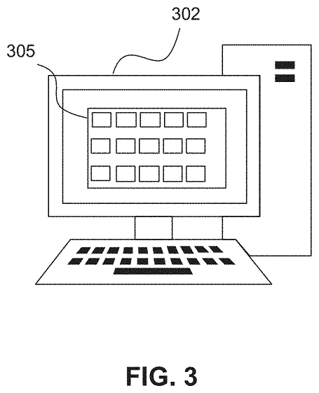

FIG. 3 illustrates an exemplary user-interface display 305 on a user-interface device 302 (e.g., a computer). In some embodiments, user-interface device 302 may include, but not limited to, a handheld display device (e.g., tablet 119A), a smart phone (e.g., mobile device/PDA 119B), a computer (e.g., computer 119C), a body-mounted display, a head-mounted display, etc. User-interface device 302 may be substantially similar to mobile devices such as, for example, computer 119C of FIG. 1A. User-interface device 302 may communicate and exchange information with WMS 119.

User-interface display 305 may comprise information including information related with inventory reports, customer orders, performance charts, status reports, process steps for movement of items in and out of FC 200, etc. In some embodiments, user-interface display 305 may be a visual display or an audio-visual display. For example, a worker moving a fragile item such as a television set may receive an audio-visual message to seek help from another worker or to ensure that the item is securely transported to its destination within or outside FC 200. User-interface display 305 may be configured to receive user input and provide feedback to the user through user-interface device 302. For example, user-interface device 302 may provide audio, visual, or haptic notifications to the user and request the user to acknowledge a receipt of the notification through user-interface display 305. In some embodiments, user-interface display 305 may comprise status reports, process flows, staffing reports, customer orders, inventory management, etc.

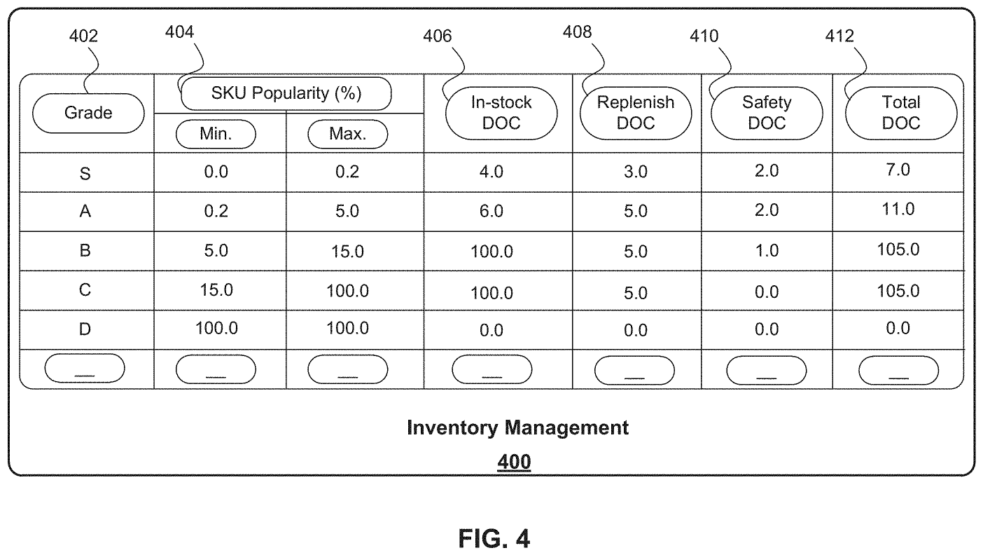

Reference is now made to FIG. 4, which illustrates an exemplary user-interface display 400 for inventory management in FC 200. User-interface display 400 may be displayed on a user-interface device (e.g., user-interface device 302). User-interface display 400 may comprise information related with currently available merchandise, forecasted demand of merchandise, planned supply of merchandise based on forecasted demand, deficit or surplus of merchandise, etc. In some embodiments, user-interface display 400 may be configured to display information categorically based on the type of items such as, for example, household furniture, stationery, produce, sporting goods, pharmacy, etc. In the context of this disclosure, an item may be referred to as a stock keeping unit (SKU). SKU may also refer to a unique identifier or a code that refers to a particular item. A SKU identifier may be, for example, a series of alpha-numeric characters, numbers, letters, or combinations thereof. It is appreciated that SKU identifiers may include or at least represent attributes associated with a product such as manufacturer, description, material, size, color, etc. and may be utilized to track the item.

User-interface display 400 may display information in a tabular format, as illustrated in FIG. 4. The exemplary table may contain a plurality of data fields arranged in an array of rows and columns. Each data field may represent information related with inventory management of SKUs such as, popularity of a SKU based on past sale records, demand and supply forecasts of SKUs, supplemental number of SKUs, quantity-on-hand, etc. User-interface display 400 may be represented in other formats including, but not limited to, graphical, textual, or combinations thereof.

In some embodiments, data fields of user-interface display 400 may be partially or completely editable based on predetermined access privileges. For example, a facility manager may have full read-write access privileges to edit user-interface display 400, one or more data fields of user-interface display 400, or to the computer system that generates user-interface display 400. Authorized personnel such as a shift supervisor or a facility manager may add, delete, review, or modify data fields, as appropriately needed. On the other hand, a worker such as a picker, may only have read access privileges such that the picker may only see data fields or data displayed in the data fields.

In some embodiments, data in the data fields of user-interface display 400 may be updated based on stored information, for example, in WMS 119, in SCM system 117, etc. Data may also be updated based on user request or a predetermined update schedule. A user may initiate a request for a current status of the inventory for one or more SKUs through user-interface display 400. Based on the received request, one or more computer-implemented systems of system 100 may obtain data from one of the databases and update the data to be displayed. In some embodiments, system (e.g., WMS 119 or SCM 117) may be configured to update the data periodically, for example, every 4 hours, or at the start of a work shift, or at the end of a work shift, etc.

In some embodiments, one or more computer-implemented systems of system 100 (e.g., WMS 119) may be configured to generate inventory status reports. The status reports may be distributed via electronic mail (e-mails), text messaging, printed notes, hand-written notes, etc. and/or made accessible to authorized personnel. The status reports may include information associated with a SKU, a category of SKUs, zone of FC 200, customer orders fulfilled, quantity-on-hand, etc. In some embodiments, status reports may also include information related with staffing such as worker efficiency, worker availability, hours worked, etc.

In some embodiments, user-interface display 400 may be configured to communicate messages to a worker, a group of workers, workers of a zone, or all the employees. The message may be generated by WMS 119. For example, WMS 119 may determine an expected time of arrival of a delivery at buffer zone 205 from a vendor and generate a message for a supervisor of buffer zone 205 to facilitate efficient unloading of delivery truck 201. The message notification on user-interface device 302 may comprise an audio, a visual, a haptic, an audio-visual notification, or combinations thereof. Other notification means may be used as well.

An exemplary user-interface display 400 for inventory management, as shown in FIG. 4, comprises a table including columns of data fields representing SKU grade 402, SKU popularity 404, in-stock amount 406, replenishment amount 408, safety amount 410, and a total amount 412. It is appreciated that data fields may be added, deleted, or modified, as appropriate.

In some embodiments, a grade may be assigned for each SKU to enable inventory management. The grades may be assigned based on, for example, popularity of the SKU. In the context of this disclosure, popularity of a SKU is determined based on a combination of at least one or more of the number of times an SKU is ordered, the quantity of the SKU ordered, the expected delivery time requested by customers, the frequency of the SKU order, etc. within a predetermined time period. For example, if the system receives an expedited delivery order for bottled water every 2 minutes within the last 24 hours, WMS 119 may identify bottled water as a popular item. Popularity of the SKU may be represented by an associated popularity index or a popularity number. In some embodiments, WMS 119 may generate a list of SKUs in a descending order of the associated popularity indices, with the most popular item on the top of the list. WMS 119 may then assign a grade to the SKUs that fall within a predetermined percentage range of their position in the list based on the associated popularity index. For example, SKUs within the top 0.2% of the popularity list may be assigned a grade S. In other words, in a list of 10,000 SKUs arranged in a descending order of their popularity indices, the top 20 SKUs would be assigned a grade S. The predetermined percentage ranges may be modified based on, for example, supply and demand of items, time of the year, availability of workers, etc.

WMS 119 may categorize a SKU in one of exemplary grades S, A, B, C, D etc., as illustrated in FIG. 4, based on predetermined percentage range of the popularity of the SKUs. For example, grade A represents SKUs in the range of 0.2% to 5% of most popular items, grade B represents SKUs in the range of 5% to 15% of most popular items, and grade C represents SKUs in the range of 15% to 100% of most popular items. In some embodiments, SKUs are categorized in grade D when there is no need to reorder those items. Other grade identifiers and percentage ranges may be used as well.

In some embodiments, managing inventory may include determining a minimum quantity of a SKU needed in stock to fulfill customer orders for a specified projected time period, represented by days-of-cover (DOC). WMS 119 may be configured to determine DOC values based on daily demand for a SKU. As depicted in FIG. 4, user-interface display 400 (e.g., a tabular data representation) may comprise inventory information including SKU grade, in-stock DOC, replenishment DOC, safety DOC, and total DOC. Each SKU grade may be assigned a replenishment DOC and a safety DOC by WMS 119, or manually by authorized personnel.

In some embodiments, WMS 119 or authorized personnel may determine an in-stock DOC value based on a ratio of the quantity of a SKU of a specific grade available in-stock to the average daily demand for the SKU. For example, if the average daily consumption of a box of cookies is 15 and the available in-stock quantity for the box of cookies is 60, then the in-stock DOC for the box of cookies may be determined as 4.0.

In some embodiments, WMS 119 or authorized personnel may determine a safety DOC value of a SKU based on a ratio of the minimum quantity of a SKU of a specific grade to be maintained available to the average daily consumption of the SKU. The safety DOC value may be determined based on SKU grade or SKU popularity. More popular SKUs such as those represented by S grade may be assigned a higher safety DOC value in anticipation of potential expedited orders, expected or unexpected. Less popular SKUs such as B or C grade SKUs may be assigned a lower safety DOC value to ensure efficient inventory management by at least reducing inventory build-up and associated costs. A higher safety DOC value may ensure timely fulfillment of customer orders while a lower safety DOC value may enhance overall efficiency.

In some embodiments, WMS 119 or authorized personnel may determine a replenishment DOC value based on a ratio of quantity of a SKU to be replenished when the in-stock DOC value drops below the safety DOC value assigned for the SKU grade to the average daily consumption of the SKU.

In some embodiments, WMS 119 or authorized personnel may determine a total DOC value based on the sum of an in-stock DOC value and a replenishment DOC value for the associated SKU grade. In some embodiments, the quantity of a SKU to be replenished may be determined based on the forecasted daily quantity of the SKU to be shipped and a predetermined number of days. The forecasted quantity may be based on historical sales records for the SKU. For example, if 10 pieces of item A were sold every day for the last 30 days, the replenishment amount may be 20, based on a projected daily consumption of 10 pieces for the next 2 days.

As an example, user-interface display 400 illustrated in FIG. 4 displays inventory management data including SKU grade 402, SKU popularity 404, in-stock DOC 406, replenishment DOC 408, safety DOC 410, and total DOC 412. For SKU grade S, the popularity range may be defined as the top 0 to 0.2% of the popular items. A safety DOC value of 2.0 is predetermined based on SKU grade and the in-stock DOC value of 4.0 with a replenishment DOC value of 3.0. In other words, if the in-stock DOC value of an item in S grade drops below the set safety DOC value 2.0, the computer-implemented system may create an order to obtain an amount of the item based on the replenishment DOC value of 3.0. The total DOC value indicates the total number of days-of-cover for items in the grade SKU, for example, a value of 7.0 for S grade SKUs, as illustrated in FIG. 4. In some embodiments, authorized personnel may utilize this information to determine the overall status of inventory and update other components of the system such as, for example, WMS 119, SCM 117, internal and external front-end system, FC Auth 123, LMS 125, etc.

In some embodiments, user-interface display 400 may be generated for each item within a SKU grade category. For example, the in-stock quantity, replenishment quantity, safety quantity, and total quantity may be updated for each of the SKUs within S grade. Similar inventory management tables may be created for a number of items, grades, movement of items between zones, etc.

In some embodiments, WMS 119 or authorized personnel may determine whether one or more SKUs within SKU grade 402 have dropped below the minimum or safety DOC value. WMS 119 may be configured to create an order for a buffer zone worker to obtain an amount of that SKU from buffer zone 205 and move it to drop zone 207. WMS 119 may comprise an algorithm, a software, or a processor configured to execute the algorithm or software. WMS 119 may be integrated with computerized system 100 and may communicate with one or more components of computerized system 100.

In some embodiments, WMS 119 may be configured to create urgent orders based on the availability of items to fulfill customer request. WMS 119 may receive the customer order and determine whether the item or the quantity of an item requested is available in stock. Based on the determination, WMS 119 may create an order to move items from buffer zone 205 to picking zone 209 or create a request to contact the vendor to deliver the item to FC 200.

In some embodiments, the back-end system such as WMS 119 or SCM system 117 may create an order based on critical pull time (CPT), referred to herein as, the lead-time needed to ensure item is packed and ready to be loaded on delivery truck 222. In some embodiments, SCM system 117 or WMS 119 may determine the CPT for a customer order based on one of a type of request, customer status, customer location, delivery request time, etc. For example, CPTs may be shorter for expedited delivery order requests compared to normal delivery orders. In some embodiments, CPTs may be determined based on a combination of one of an item requested by the customer, type of request, customer location, customer status, etc.

Once WMS 119 or SCM system 117 creates an order based on determining whether the in-stock DOC value has dropped below the safety DOC value for the SKU, the order may be placed in a queue based on the urgency associated with the order. In some embodiments, unfulfilled customer orders nearing the end of their CPT may be marked urgent. The buffer zone worker may receive one of an audio, a visual, a haptic, or an audio-visual notification on mobile device (e.g., one or more of mobile devices 119A-C) to expedite the fulfillment of the urgent order. In some embodiments, the notification may comprise a count-down timer based on the CPT, indicating the remaining time for finishing the request to ensure a timely package delivery to the customer.

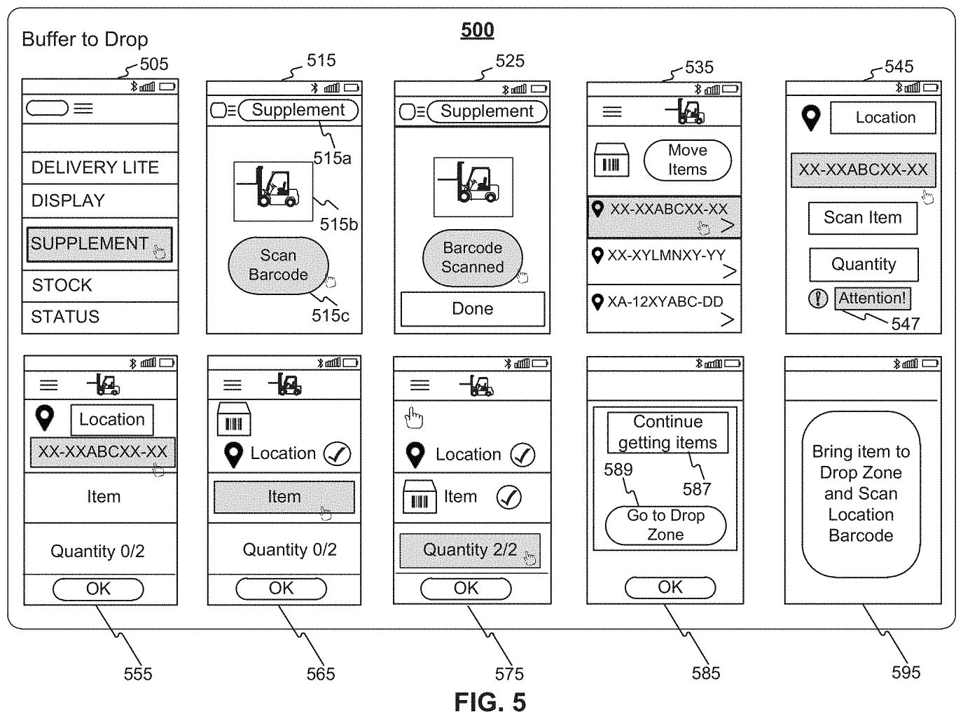

Reference is now made to FIG. 5, which illustrates an exemplary user-interface display 500 including interactive elements 505-595 utilized for facilitating movement of items from buffer zone 205 to drop zone 207 of FC 200, consistent with disclosed embodiments. It is appreciated that interactive elements may be added, deleted, modified, customized, or the like, as appropriate. In a preferred embodiment, interface displays such as user-interface display 400 or 500 may be displayed on mobile devices 119A (e.g., handheld PDAs or tablets) or 119B (e.g., smart mobile phones). Mobile devices may be configured to receive instructions from one or more computer-implemented systems of system 100. In the context of this disclosure, instructions, as used herein may comprise a single instruction, an instruction to initiate a process, a transport-layer protocol request such as a transmission control protocol (TCP) or a user-datagram protocol (UDP), an application layer protocol requests such as hyper-text transfer protocol (HTTP), simple mail transfer protocol (SMTP), remote desktop protocol (RDP), an individual HTTP request, or the like.

Once WMS 119 creates an order for buffer zone worker to obtain an item or a requested quantity of the item and move it to drop zone 207, user-interface display 500 may be displayed on user-interface device 302. In some embodiments, WMS 119 may cause one or more computer-implemented systems of system 100 to activate a display module including user-interface display 500 on user-interface device 302 for the buffer zone worker. In some embodiments, the buffer zone worker may activate the display module including user-interface display 500 on user-interface device 302 or on mobile device (e.g., 119A-C).

The process of moving items from buffer zone 205 to drop zone 207 may comprise a plurality of steps including initiating the process, verifying user identity, satisfying order requirements, verifying order fulfillment, and delivering items to drop zone 207. The process may be modified by adding, deleting, or altering one or more steps.

Interactive element 505 of user-interface display 500 may provide a user or a buffer zone worker with options to select a job type including displaying status, stock, supplementing, etc. In the context of this disclosure, supplementing refers to replenishing the stock with SKUs based on the information received from, for example, WMS 119 or authorized personnel. The options displayed in interface element 505 may be reconfigurable based on a number of factors including request type, associated zones, process steps etc. In some embodiments, options may be added, deleted, modified, or highlighted, as required. The buffer zone worker may select the highlighted option “Supplement” to start the process of moving an item from buffer zone 205 to drop zone 207. In some embodiments, interface element 505 may be configured to receive user input. The user input may comprise a touch signal, a click signal, an audio signal, or combinations thereof. Upon receiving the user input, the supplementing process, or the process of moving items out of buffer zone 205 to picking zone 209 may begin, as depicted in interactive element 515.

Interactive element 515 may comprise sub-elements 515a-c displayed within. Sub-element 515a may indicate the overall process type such as, for example, supplement. In some embodiments, if the request is an urgent customer order, sub-element 515a may comprise one of a graphic or textual indication of the request type, for example, by highlighting, or a flashing visual indication, or an audible read-out of the text displayed in sub-element 515a. Sub-element 515b may indicate a suggested means of transporting the item or items in the order being satisfied. For example, sub-element 515b displays forklift 206. In some embodiments, back-end system (e.g., WMS 119 or SCM system 117) may determine the suggested means of transporting the items in the order based on the size, quantity, weight, or the like. Other means of transporting the items may include, but is not limited to, a pallet, a handtruck, a tote, a cart, or a trolley. Sub-element 515c may indicate an instruction for the user prompting a user input. In some embodiments, the user input may comprise user identification. One or more computer-implemented systems of system 100 such as WMS 119 may be configured to authenticate user based on user identification information provided by the user. For example, sub-element 515c may request the buffer zone worker to scan the employee barcode. Other known methods of identification authentication such as finger printing, retinal scans, passwords, etc. may be employed as well. The results of identification authentication may be displayed in the next step represented by interactive element 525.

Interactive element 525 may be configured to display the type of identification input provided by the user and the results of the identification authentication. Based on the results of the identification authentication, interactive element 525 may allow the user to proceed to the next step and start the process of obtaining items from buffer zone 205 and moving to drop zone 207.

Interactive element 535 may display the list of items to be moved from buffer zone 205 to drop zone 207. In some embodiments, WMS 119 may generate the list of items that need to be moved. The user may select at least one item from the list, e.g., by tapping on one of the items in the list. Each of the listing in interactive element 535 may comprise item information, item location in buffer zone 205, and quantity of item to be moved. The buffer zone worker may select one or more item listings to further review the details associated with the item, as illustrated in interactive element 545.

Upon selecting at least an item from the list, the user may be directed to the next step of the process illustrated in interactive element 545. In some embodiments, interactive element 545 may display the details of the item selected to be moved in interactive element 535. The details may include, but are not limited to, location of the item in buffer zone 205, item description, and quantity of item to be moved. In some embodiments, location of the item may comprise textual or visual information, for example, a floor map of buffer zone 205 or the region of buffer zone 205 with the location of the selected item highlighted. In some embodiments, interactive element 545 may display directions to the selected location.

In some embodiments, interactive element 545 may comprise sub-element 547 configured to display one or more notifications for the user. Sub-element 547 may be further configured to receive one or more user input in response to the notification. For example, sub-element 547 may display a message requesting the buffer zone worker to bring an empty pallet or a tote and start collecting items to be moved. In response to the notification, the user may provide an input. The user input may be received by WMS 119. In some embodiments, the user input received may be stored in a local storage device or a global storage device in system 100. Based on the received input, interactive element 545 may allow the user to proceed to the next step represented by interactive element 555.

Interactive element 555-575 may display the details of the item selected to be moved in interactive element 535. The details may include, but are not limited to, location of the item in buffer zone 205, item description, and quantity of item to be moved. As illustrated, location of the item in buffer zone 205 may be highlighted in interactive element 555, description of the item may be highlighted in interactive element 565, and quantity of the item to be moved may be highlighted in interactive element 575. Interactive element 555 may represent a process of scanning the location barcode of the item in buffer zone 205, interactive element 565 may represent a process of scanning the item, and interactive element 575 may represent a process of scanning the quantity of the item the buffer zone worker is moving. The user may be required to confirm the accuracy of the order being fulfilled at every step. For example, interactive elements (not pictured) may comprise a sub-element configured to receive user input associated with confirmation of the accuracy of the order being fulfilled. It is appreciated that interactive elements may be added, deleted, re-ordered, modified, as appropriate.

Interactive element 585 may include sub-elements 587 and 589 configured to receive user input. For example, as illustrated, sub-element 587 may be selected by the buffer zone worker if the order is incomplete and more items need to be added before moving to drop zone 207. Sub-element may be selected by the buffer zone worker if the order is complete and all the items to be moved are collected and ready to be moved to drop zone 207. Based on the received user input, the buffer zone worker may be directed to interactive element 535 to select the item to be moved, or to interactive element 595.

Interactive element 595 may instruct the buffer zone worker to move the collected items to drop zone 207 and scan the location barcode of drop zone 207 where the items are placed. In some embodiments, drop zone 207 may comprise item placement or storage units such as racks, shelves, containers, spaces in walls, etc., and each placement unit may be identified by a unique identification code. The buffer zone worker may scan the unique identification code of the placement unit receiving the item.

Moving items from buffer zone 205 to picking zone 209 may comprise a two-step process. The first step may include moving items from buffer zone 205 to drop zone 207, and the second step may include moving the items from drop zone 207 to picking zone 209.

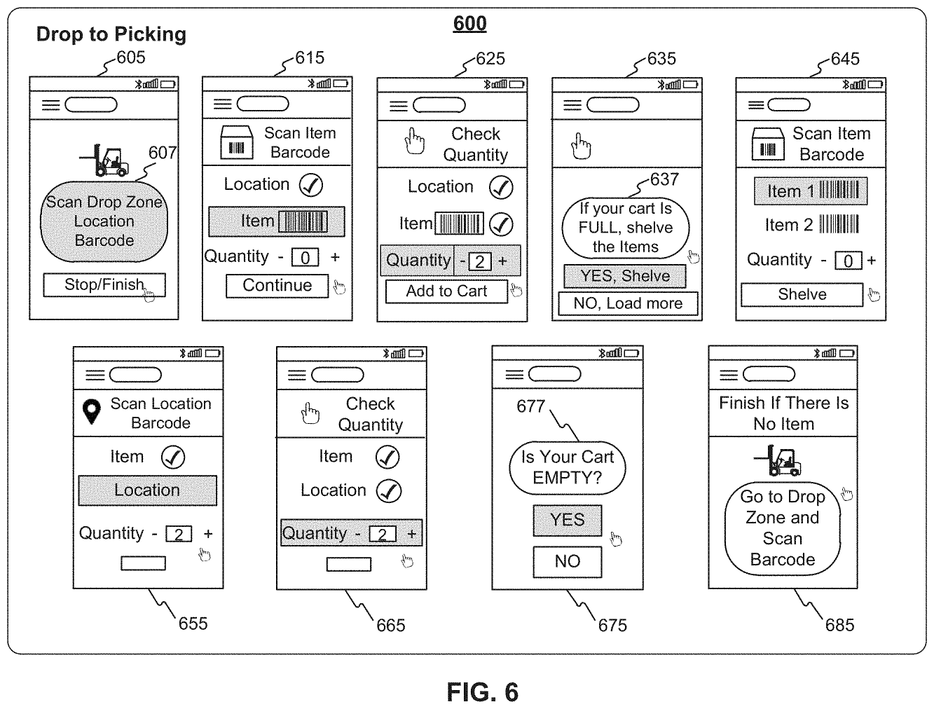

Reference is now made to FIG. 6, which illustrates an exemplary user-interface display 600 including interactive elements 605-685 utilized for facilitating movement of items from drop zone 207 to picking zone 209 of FC 200, consistent with disclosed embodiments. Moving items from drop zone 207 to picking zone 209 may include a plurality of steps including initiation, moving to picking zone 209, and shelving items in the picking zone. It is appreciated that interactive elements may be added, deleted, modified, customized, or the like, as appropriate.

Interactive element 605 may comprise the initiation of the second step of moving items from drop zone 207 to picking zone 209. Sub-element 607 may display a message for a drop zone worker to scan the drop zone location barcode to begin the moving process. The drop zone location barcode may comprise information associated with the location of the item within drop zone where the item was delivered from buffer zone 205. In some embodiments, interactive element 605 may comprise sub-elements (not pictured) to indicate a suggested means of transporting the items, for example, a forklift (as illustrated), a pallet, a tote, a cart, a trolley, a handtruck, etc. Interactive element 605 may represent the process of scanning the location barcode of drop zone 207. Upon successfully scanning the location barcode, the drop zone worker may be prompted to select the item to be moved, as shown in the next step represented in the next step.

Interactive elements 615 may display at least some of the details associated with the item to be moved. The details may include location of the item in drop zone 207, description of the item, and quantity of the item to be moved. Once the location of the item in the drop zone is scanned, the description of the item may be highlighted. Interactive element 615 may represent the process of scanning the item to be moved. Upon scanning the item to be moved, the drop zone worker may be directed to select the quantity of the item to be moved represented in the next step.

Once the drop zone worker scans the item to be moved, as illustrated in interactive element 615, the drop zone worker may verify the quantity of the item to be moved. Interactive element 625 comprises a sub-element configured to receive input related to the quantity of the item to be moved. For example, the drop zone worker may be allowed to input the quantity added to the cart based on the order or the request. Upon satisfying the order requirements, the drop zone worker may verify the fulfillment of the order by verifying the details of the item displayed in interactive element 625, before proceeding to the next step.

Interactive element 635 may be configured to display sub-element 637. In some embodiments, sub-element 637 may request an input from the drop zone worker to determine whether the cart (or forklift, tote, trolley etc.) is full. Based on the input received, the drop zone worker may be directed to the step represented by interactive element 605 to load more items on the cart or to the next step represented by interactive element 645 to shelve the items in the cart.

Interactive elements 645-665 may be associated with shelving the items in shelves located in picking zone 209. Interactive element 645 may be configured to display the listing of items to be shelved in picking zone 209 based on the order. Interactive element 655 may be configured to display the shelf location where the item may be shelved. Each shelf in picking zone 209 may be identified by a unique identification such as, for example, an alpha-numeric code. Interactive element 665 may be configured to display the quantity of the item shelved.

Interactive element 675 may be configured to display sub-element 677. In some embodiments, sub-element 677 may request an input from the drop zone worker to determine whether the cart is empty. Based on the input received, the drop zone worker may be directed to the step represented by interactive element 645 to shelve the remaining items in the cart or to the next step represented by interactive element 685. As an example, as illustrated in interactive element 675, the input received (YES) in response to the request configured to determine whether the cart is empty, from the drop zone worker is highlighted.

Interactive element 685 may be configured to display instructions to the drop zone worker to restart the process of moving items from drop zone 207 to picking zone 209. In some embodiments, the drop zone worker may be directed to the step represented by interactive element 605 to re-start the movement of items from drop zone to picking zone. In some embodiments, interactive element 685 may comprise a sub-element (not shown) configured to receive input from the drop zone worker, allowing the drop zone worker to log off from system, for example, at the end of the shift or for a break.

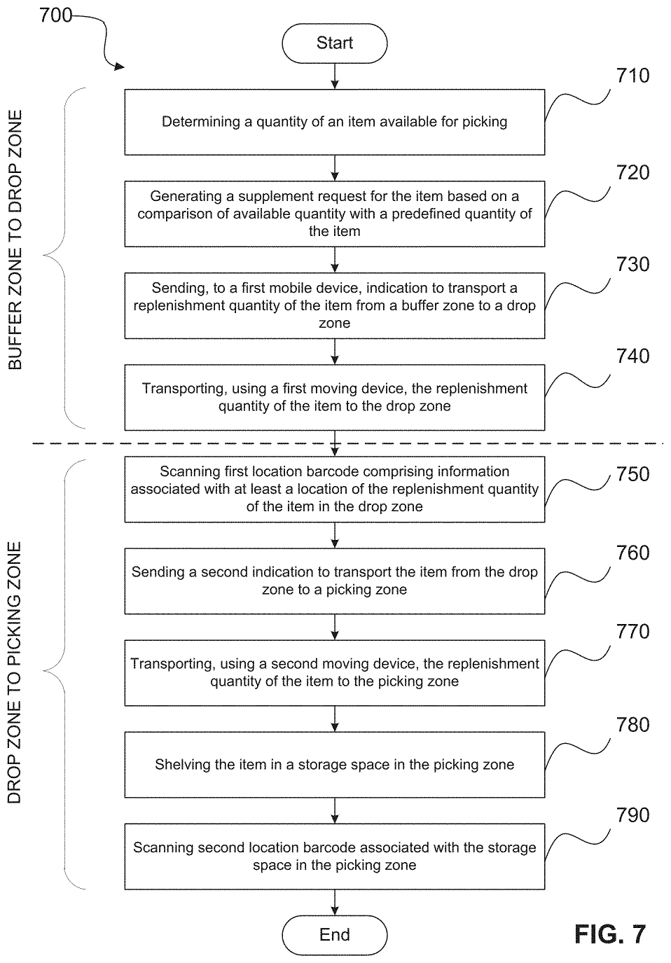

Reference is now made to FIG. 7, which illustrates an exemplary flowchart of process 700 for distributing tasks to workers moving items between different physical zones (e.g., buffer zone 205, drop zone 207, and picking zone 209) of a fulfillment center (e.g., FC 200). In some embodiments, process 700 may comprise two phases—a first phase including the steps for moving an item from buffer zone 205 to drop zone 207 and a second phase including the steps for moving the item from drop zone 207 to picking zone 209. The combination of the two phases, as illustrated in FIG. 7, is intended to be understood as a set of steps to move a single item from buffer zone 205 to picking zone 209, but one of skill will understand that not all steps in process 700 must be performed in the same time period. For example, after moving an item from buffer zone 205 to drop zone 207 (steps 710-740) that item may remain in drop zone 207 for hours, days, or weeks, before moving the item to picking zone 209 (steps 750-790). In some embodiments, steps 710-740 relate to processes depicted in interactive elements shown in FIG. 5, while steps 750-790 relate to processes depicted in interactive elements shown in FIG. 6.

In step 710, one or more computer-implemented systems (e.g., WMS 119) of system 100 may determine a quantity of an item available in a picking zone. The quantity of the item available in the picking zone may be the in-stock quantity. In some embodiments, the available quantity of an item may be represented by DOC. The DOC values may be determined based on a forecasted daily shipping quantity of the item. For example, an in-stock DOC value of 4.0 may indicate that 4 days' worth of supply for the item may be available in stock, based on a predetermined daily average quantity of the item shipped.

In step 720, WMS 119 or authorized personnel may generate an order for supplementing the item to the picking zone based on a comparison of the available quantity with a predefined quantity of the item. The predefined quantity of the item may be a safety amount stored in the fulfillment center (e.g., FC 200) for urgent orders, expected or unexpected. In some embodiments, the comparison may include determining if the available quantity is equal to or less than the predetermined safety amount for the item and generating an order internally for supplementing the item by moving at least a replenishment quantity of the item from a buffer zone (e.g., buffer zone 205) to a drop zone (e.g., drop zone 207).

In step 730, WMS 119 may send an indication to a mobile device (e.g., mobile device 119A or 119B) to transport the replenishment quantity of the item from the buffer zone to the drop zone. The replenishment quantity may be determined based on a number of factors including, but are not limited to, previous daily sales records, forecasted daily sales, combinations thereof, etc. For example, the replenishment amount may be calculated based on the average daily quantity of the item shipped over the last 30 days and may include the forecasted daily quantity of the items to be shipped for the next 2 days. In other words, if 10 pieces of item A were sold every day for the last 30 days, the replenishment amount may be 20, based on a projected daily consumption of 10 pieces for the next 2 days.

WMS 119 may communicate with the mobile device operated by the buffer zone worker. In some embodiments, WMS 119 may exchange information and messages with the mobile device. The mobile device may receive the indication as a text message, a data message, a phone call, or the like. The indication may comprise an audio message, an audio-visual message, a visual message, other data, or the like. In some embodiments, the indication may prompt the user to acknowledge receipt of the message. The user may be a buffer zone worker or operator of the mobile device. WMS 119 may be configured to receive the user input and store the information in a local or a global memory.

In step 740, the buffer zone worker may transport the replenishment quantity of the item from the buffer zone to the drop zone, using a moving device (e.g., mobile device 119A or 119B). A user-interface display (e.g., user interface display 500) may comprise interactive elements (e.g., interactive element 515) configured to display details associated with the order including, the overall process type such as, for example, supplement, or customer order, urgent customer order, etc. In some embodiments, if the request is an urgent customer order, interactive element 515 may display a graphic or textual indication of the request type, for example, by highlighting, or a flashing visual indication, or an audible read-out of the text displayed. In some embodiments, the interactive element may indicate a suggested means of transporting (e.g., forklift 206) the replenishment quantity of the item in the order. In some embodiments, WMS 119 may determine the suggested means of transporting the items in the order based on the size, quantity, weight of the item, or the like, and provide the suggested means to mobile device (e.g., mobile device 119A or 119B).

In some embodiments, WMS 119 may be configured to authenticate the user based on user identification information provided by the user. For example, WMS 119 may generate a message to be displayed on the user interface display requesting the buffer zone worker to scan a form of identification, (e.g., employee barcode). Other known methods of identification authentication such as finger print recognition, retinal scans, passwords, etc. may be employed as well. WMS 119 may process the identification information provided by the buffer zone worker and determine whether the buffer zone worker may proceed with moving the items.

In some embodiments, steps 750-790, which in some embodiments relate to a sub-process of moving items from drop zone 207 to picking zone 209, may occur substantially later than steps 710-740. For example, while steps 710-740 may occur during the morning of a first day, during which a particular item is moved from buffer zone 205 to drop zone 207, steps 750-790 may occur at a later time during the same day or the next day, based on an order of priority determined by one or more computer-implemented systems of system 100 (e.g., SAT system 101, WMS system 119, or SCM system 117).

In step 750, a barcode scanner (e.g., on mobile device 119A or 119B) may scan a location barcode comprising information associated with at least a location of the replenishment quantity of the item in the drop zone. The barcode scanner may be configured to communicate with one or more computer-implemented systems of system 100. In some embodiments, the mobile device may be equipped with barcode scanning capabilities. WMS 119 may receive the scan data from the barcode scanner, process the scan data, and communicate with the mobile device.

In step 760, WMS 119 may send an indication to the mobile device such as 119A or 119B, to transport the replenishment quantity of the item from the drop zone location to picking zone 209. The indication may include instructions for the drop zone worker to move the items. For example, item description, quantity of the item, order number to which the item belongs, etc. The mobile device may receive the indication as a text message, a data message, a phone call, or the like. The indication may comprise an audio message, an audio-visual message, a visual message, other data, or the like.

In step 770, the drop zone worker may transport the replenishment quantity of the item to the picking zone 209 using a moving device. In some embodiments, the user-interface display may indicate a suggested means of transporting (e.g., forklift 206) the replenishment quantity of the item in the order. In some embodiments, WMS 119 may determine the suggested means of transporting the items in the order based on the size, quantity, weight of the item, or the like.

In step 780, the drop zone worker may shelve the replenishment quantity of items in a storage space in picking zone 209. The storage space in picking zone 209 may comprise racks, shelves, containers, totes, bins, etc. Each storage space may be identified by a unique identification such as, for example, a barcode, an alpha-numeric code, etc. comprising information associated with at least the location of the storage space within picking zone 209.

In step 790, a barcode scanner (e.g., on mobile device 119A or 119B) may scan the location barcode or the alpha-numeric code of the storage space where each of the replenishment quantity of the item has been shelved in step 780. The barcode scanner may be configured to communicate with one or more computer-implemented systems of system 100. In some embodiments, the mobile device may be equipped with barcode scanning capabilities. WMS 119 may receive the scan data from the barcode scanner, process the scan data, and communicate with the mobile device. In some embodiments, WMS 119 may send a notification or an indication to the mobile device. The notification may include a message informing the drop zone worker of successful completion of the moving process. The notification may include a message prompting user input to confirm whether all the items are shelved. Based on the user input WMS 119 may send indications to the mobile device for the drop zone worker to restart the process of moving items from drop zone 207 to picking zone 209.

In some embodiments, a database associated with the one or more computer-implemented systems of system 100 may be configured to store information recorded by a user device (e.g., mobile device 119A or 119B), for example, by scanning a barcode. In some embodiments, the database may be configured to store information received from one or more user-inputs through a user-interface, for example, the item identifier representing information related with location of the item, description of the item, or quantity of the item. One or more computer-implemented systems of system 100 (e.g., WMS 119, SCM 117, SAT 101) or another database within system 100 may request and retrieve information stored in the database using known methods (e.g., SQL queries). The information in the database may be updated, or upon request. In some embodiments, the information in the database may be updated upon recording of the information by the user or upon receiving a user-input. For example, if the user transports a quantity (n) of an item from buffer zone 205 to drop zone 207 and records the information through a user-device, the updated information may be stored in the database. The updated information may then be accessed or used by other systems to determine whether a supplement request or a work request is warranted. It is appreciated that system 100 may comprise more than one database.

While the present disclosure has been shown and described with reference to particular embodiments thereof, it will be understood that the present disclosure can be practiced, without modification, in other environments. The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer readable media, such as secondary storage devices, for example, hard disks or CD ROM, or other forms of RAM or ROM, USB media, DVD, Blu-ray, or other optical drive media.

Computer programs based on the written description and disclosed methods are within the skill of an experienced developer. Various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

1. A computer-implemented system for managing inventory in a fulfillment center, the system comprising:
at least one user-device including an interactive element configured to receive a user input, wherein the interactive element comprises at least one sub-element displayed therein;
a memory storing instructions; and
at least one processor configured to execute the instructions to:
determine a quantity of an item available for picking;
generate a supplement request for the item based on a comparison of the quantity of the item available with a predefined quantity of the item, wherein the predefined quantity comprises a safety amount based on a popularity of the item, wherein a safety amount for a less popular item is lower than a safety amount for a more popular item;
send, to the at least one user-device for display, the supplement request to transport the item from a first zone to a second zone of the fulfillment center;
generate a dynamically adjusted order or urgency for the generated supplement request based on a delivery schedule for the item;
send, to the at least one user-device, an indication requesting to prioritize transportation of the item based on the dynamically adjusted order of urgency;
send, to the at least one sub-element, a first indication requesting input of identification information;
receive, from at least one user-device, a first input to verify the identification information;
send, to at least one user-device for display, based on the identification information, an item identifier comprising at least one of a location information of the item in the first zone, a description of the item, or a supplemental quantity of the item to be transported to the second zone;
receive, from at least one user-device, a second input representing the item identifier;
send, to at least one user-device for display, a second indication requesting recording of the location information of the item, the description of the item, and the supplemental quantity of the item to be moved to the second zone; and
store the first input, the second input and the recorded information in a database associated with the computer-implemented system.

2. The system of claim 1, wherein the popularity of the item is graded based on a shelf-time of the item in a picking zone of the fulfillment center.

3. The system of claim 1, wherein the at least one processor is configured to access the recorded information in the database to generate the supplement request.

4. The system of claim 1, wherein the comparison comprises determining whether the quantity of the item available for picking is less than the predefined quantity of the item.

5. The system of claim 2, wherein the at least one processor is configured to further execute the instructions to generate the supplement request in response to determining that the quantity of the item available for picking is less than the predefined quantity of the item in the picking zone.

6. The system of claim 1, wherein the at least one processor is configured to further execute the instructions to:
receive a plurality of supplement requests from the system; and
arrange the received plurality of supplement requests in an order of urgency.

7. The system of claim 6, wherein the at least one processor is configured to further execute the instructions to determine the order of urgency based on a critical pull time for the item.

8. (canceled)

9. The system of claim 1, wherein the at least one processor is configured to further execute the instructions to send, to at least one user-device, an indication of a transportation means to transport the item from the first zone to the second zone, the indication being based on the supplement request.

10. The system of claim 1, wherein the at least one processor is configured to further execute the instructions to receive, from at least one user-device, information associated with an identifier scanned from the user-device.

11. A computer-implemented system for managing inventory in a fulfillment center, the system comprising:
a memory storing instructions; and
at least one processor configured to execute the instructions to:
send, to at least one user-device for display, a work request to transport a replenishment quantity of an item from a first zone to a second zone of the fulfillment center;
send, to at least one user-device for display, a first indication requesting recording of a location information of the item in the first zone, a description of the item, and the replenishment quantity of the item to be transported to the second zone;
receive, from at least one user-device, a first input indicating whether a moving device configured to transport the replenishment quantity of the item is full;
send, to at least one user-device for display, a second indication requesting shelving each of the replenishment quantity of the item in a storage space in the second zone based on the received first input;
send, to at least one user-device for display, a third indication requesting recording of at least one of a location information of the storage space in the second zone, the replenishment quantity of the item shelved, and the description of the item shelved;
receive, from at least one user-device, a second input to determine whether the each of the replenishment quantity of the item is shelved; and
store the first input, the second input, and recorded information in a database associated with the computer-implemented system.

12. The system of claim 11, wherein the at least one processor is configured to further execute the instructions to determine the replenishment quantity based on at least one of past daily sales and forecasted daily sales.

13. The system of claim 11, wherein the at least one processor is configured to further execute the instructions to:
receive a plurality of work requests from the system; and
arrange the received plurality of work requests in an order of urgency.

14. The system of claim 13, wherein the at least one processor is configured to further execute the instructions to determine the order of urgency based on a critical pull time for the item.

15. The system of claim 14, wherein upon determining the order of urgency, the at least one processor is configured to further execute the instructions to cause the user-device to display an indication to prioritize transportation of the item based on the determined order of urgency.

16. The system of claim 15, wherein the at least one processor is configured to send, to at least one user-device for display, an indication of the moving device to transport the item from the first zone to the second zone, based on the work request.

17. The system of claim 11, wherein at least one of the first indication, the second indication, and the third indication comprises an audio-visual, a visual, or a haptic indication.

18. The system of claim 11, wherein each of the storage space in the second zone is identified by a unique location identifier.

19. The system of claim 11, wherein the at least one processor is configured to access the recorded information in the database to generate the work request.

20. A computer-implemented method for moving items between physical zones in a fulfillment center, the method comprising:
determining, using a computer-implemented system, a quantity of the item available for picking;
generating, using the computer-implemented system, a supplement request for the item based on a comparison of the available quantity with a predefined quantity of the item, wherein the predefined quantity comprises a safety amount based on a popularity of the item, wherein a safety amount for a less popular item is lower than a safety amount for a more popular item;
sending, to at least one user-device for display, the supplement request to transport the item from a first zone to a second zone of the fulfillment center, wherein the at least one user-device comprises an interactive element configured to receive a user input;
sending, to the at least one user-device, a dynamically adjusted order of urgency for the generated supplement request based on a delivery schedule for the item, and an indication requesting to prioritize transportation of the item based on the adjusted order of urgency, wherein the indication comprises a graphical, textual, or audible notification by a sub-element of the interactive element;
sending, to at least one user-device for display, a first indication requesting input of identification information;
receiving, from at least one user-device, a first input to verify the identification information;
sending, to at least one user-device for display, based on the identification information, an item identifier comprising at least one of a location information of the item in the first zone, a description of the item, or a supplemental quantity of the item to be transported to the second zone;
receiving, from at least one user-device, a second input representing the item identifier;
sending, to at least one user-device for display, a second indication requesting recording the location information of the item, the description of the item, and the supplemental quantity of the item to be moved to the second zone;
sending, to at least one user-device for display, a work request to transport a replenishment quantity of an item from the second zone to a third zone of the fulfillment center;
sending, to at least one user-device for display, a third indication requesting recording of a location information of the item in the second zone, a description of the item, and the replenishment quantity of the item to be transported to the third zone;
receiving, from at least one user-device, a third input indicating whether a moving device configured to transport the replenishment quantity of the item is full;
sending, to at least one user-device for display, a fourth indication requesting shelving of each of the replenishment quantity of the item in a storage space in the third zone based on the received third input;
sending, to at least one user-device for display, a fifth indication requesting recording at least one of a location information of the storage space in the second zone, the replenishment quantity of the item shelved, and the description of the item shelved;
receiving, from at least one user-device, a fourth input to determine whether each of the replenishment quantity of the item is shelved; and
storing each of the first input, the second input, the third input, the fourth input, the fifth input, and recorded information in a database associated with the computer-implemented system.

21. The system of claim 1, wherein the interactive element comprises a sub-element that provides an indication of request type through highlighting, a flashing visual indication, or an audible read-out of displayed text.
